(19) United States
(12) Patent Application Publication
(10) Pub. No.: US 2020/0170262 A1
(43) Pub. Date: Jun. 4, 2020

(54) HIGH PROTEIN BAKED EGG CHIP

(71) Applicant: Cargill, Incorporated, Wayzata, MN (US)

(72) Inventor: Aaron REED, Columbia Heights, MN (US)

(21) Appl. No.: 16/631,743

(22) PCT Filed: Jul. 20, 2018
(86) PCT No.: PCT/US2018/043098

§ 371 Date: Jan. 16, 2020

Related U.S. Application Data
(60) Provisional application No. 62/535,060, filed on Jul. 20, 2017.

(51) Int. Cl. A21D 2/26; A21D 2/18; A21D 13/45; A23L 15/00

(52) U.S. Cl. CPC A21D 2/262; A21D 2/186; A23V 2002/00; A23L 15/20; A21D 13/45

(57) ABSTRACT

A baked snack food product is prepared by a method comprising preparation of a composition comprising (i) 75 wt % to about 95 wt % egg white, (ii) from about 5 wt % to about 15 wt % cook-up starch, and (iii) from about 2 wt % to about 6 wt % instant starch; the composition having a viscosity of from about 200 to about 1700 cPs. This composition is deposited on a baking surface, baked, and dried to a moisture content of from about 2% to about 10%. Baked snack food products are also described.

### CROSS REFERENCE TO RELATED APPLICATION

This application claims the benefit of the U.S. Provisional Patent application Ser. No. 62/535,060, filed Jul. 20, 2017 entitled HIGH PROTEIN BAKED EGG CHIP, which is incorporated by reference in its entirety.

### FIELD

The present disclosure relates to systems for snack products. More specifically, the present application relates to a high protein egg chip.

### BACKGROUND

Consumer snacking behavior is changing. Snacking has expanded to occur at all times in the day and is often looked upon as a meal replacement. The demand for healthier snacks continues to grow with an emphasis on products bearing claims for protein, absence of gluten, and being made from a simple list of ingredients.

One category of popular snack products is the crisp snack foods known as “chips” in the United States and as “crisps” in Europe. These products are usually fried and have high fat and carbohydrate content. Very low-density snack products are also common in the marketplace, such as popcorn and cheese curls or cheese puffs. These products often also have high fat and carbohydrate content.

US Patent Application Publication Nos. 2014/0065285; 2014/0154395; 2014/0220225; and 2015/0064334, all to Alden, describe crunchy egg products that are stated to comprise a high egg percentage by volume and a low water content by weight, audible fracturing characteristics, and brittleness characteristics.

US Patent Application Publication No. 2005/0089623 to Fannon describes a proteinacious food product formed by extrusion that is a stated to be a crisp or frangible product that is high in protein. The protein source for this product is preferably selected from seed products and legumes.

US Patent Application Publication No. 2013/0022731 to Olson relates to high protein, low carbohydrate meal replacements and food. The Summary of the Invention indicates that the invention described therein relates to a new class of food that is crispy, tasty, and low in carbohydrates and has substantial levels of egg white protein and suitable shelf life for packaging in ready-to-eat form.

### SUMMARY

A baked snack food product is prepared by a method comprising preparation of a composition comprising i) from about 75 wt % to about 99.95% egg white, ii) a polysaccharide selected from the group comprising instant starch, cook-up starch, xanthan gum, and mixtures thereof, wherein the instant starch is from about 2 wt % to about 6 wt %, the cook-up starch is from about 5 wt % to about 29 wt %, and the xanthan gum is from about 0.05 wt % to about 0.4 wt %, the composition having a viscosity from about 40 cPs to about 1400 cPs at a temperature from about 52° F. to about 55° F. This composition is deposited on a baking surface and is baked to a moisture content from about 40% to about 85%, and dried to a moisture content from about 2% to about 10%. The thickness of the baked snack food product is from about 0.03 inch to about 0.09 inch.

A baked snack food product is prepared by a method comprising preparation of a composition comprising i) from about 75 wt % to about 95 wt % egg white, ii) from about 5 wt % to about 15 wt % cook-up starch, and iii) from about 2 wt % to about 6 wt % instant starch, the composition having a viscosity from about 300 cPs to about 1500 cPs at 50° F. This composition is deposited on a baking surface and is baked to a moisture content from about 60% to about 80%, and dried to a moisture content from about 2% to about 8%. The thickness of the baked snack food product is from about 0.03 inch to about 0.06 inch.

In another aspect, a baked snack food is prepared by a method of comprising preparation of a composition comprising i) liquid egg white from about 80 wt % to about 93 wt %, or from about 84 wt % to about 90 wt %, ii) cook-up starch from about 5 wt % to about 12 wt %, or from about 5 wt % to about 9 wt %, and (iii) instant starch from about 2 wt % to about 6 wt %, the composition having a viscosity from about 300 cPs to about 1300 cPs, or from about 600 cPs to about 1300 at 50° F. This composition is deposited on a baking surface and is baked to a moisture content from about 60% to about 80%, and dried to a moisture content from about 2% to about 8%. The thickness of the baked snack food product is from about 0.03 inch to about 0.06 inch.

A baked snack food product is provided having a pre-cooked composition of from about 75 wt % to about 95 wt % egg white, from about 5 wt % to about 15 wt % cook-up starch, and from about 2 wt % to about 6 wt % instant starch. The baked snack food product has a moisture content from about 2% to about 10%, and a thickness from about 0.03 inch to about 0.06 inch.

In another aspect, a baked snack food product is provided having a pre-cooked composition of i) egg white from about 80 wt % to about 93 wt %, or from about 84 wt % to about 90 wt %, ii) cook-up starch from about 5 wt % to about 12 wt %, or from about 5 wt % to about 9 wt %, and (iii) instant starch from about 2 wt % to about 6 wt %. The baked snack food product has a moisture content from about 2% to about 8% or from about 2% to about 5%, and a thickness about 0.03 inch to about 0.06 inch.

A baked snack food product is provided having a pre-cooked composition of from about 75 wt % to about 99.95 wt % egg white, a polysaccharide selected from the group comprising instant starch, cook-up starch, xanthan gum, and mixtures thereof, wherein the instant starch is from about 2 wt % to about 6 wt %, the cook-up starch is from about 5 wt % to about 29 wt %, and the xanthan gum is from about 0.05 wt % to about 0.4 wt %, the composition having a viscosity from about 40 cPs to about 1400 cPs at a temperature from about 52° F. to about 55° F. The baked snack food product has a moisture content from about 2% to about 10%, and a thickness from about 0.03 to about 0.09 inch.

The baked snack food product has excellent organoleptic properties while at the same time serving as a good source of protein with low fat, low or no cholesterol and low or no gluten content. These excellent properties are afforded due to the selection of ingredients and preparation of the final baked snack food product by baking.

The baked snack food product in an aspect has a protein content of at least about 10 g per 30 g serving. The baked snack food product in an aspect has a fat content of no more than about 2 g per 30 g serving. The baked snack food product in an aspect has a cholesterol content of no more than about 2 g per 30 g serving.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this application, illustrate several aspects of the present disclosure and together with a description of the embodiments serve to explain the principles of the present disclosure. A brief description of the drawings is as follows:

FIG. 1A is a photograph showing a perspective view of baked snack food products.

FIG. 1B is a photograph showing a perspective view of baked snack food products.

FIG. 2 is a photograph showing a perspective view of a comparison of baked snack food products.

FIG. 3 is a photograph showing an enlarged view of a baked snack food product.

FIG. 4 is a photograph showing a side view of measurement of thickness of a baked snack food product.

FIG. 5 is a photograph showing a side view of a testing apparatus for determination of the Fracturability Value of a baked snack food product.

### DETAILED DESCRIPTION

The aspects of the present disclosure described below are not intended to be exhaustive or to limit the present disclosure to the precise forms disclosed in the following detailed description. Rather a purpose of the aspects chosen and described is by way of illustration or example, so that the appreciation and understanding by others skilled in the art of the general principles and practices of the present disclosure can be facilitated.

As noted above, the baked snack food product is made from a composition that comprises from about 75 wt % to about 99.95 wt % egg white. In an aspect, the composition comprises from about 75 wt % to about 95 wt % egg white. In another aspect, composition comprises from about 80 wt % to about 99.8 wt % egg white. In another aspect, the composition comprises from about 85 wt % to about 99.7 wt %. In yet another aspect, the composition comprises from about 88 wt % to about 99.6 wt %. Further aspects of the composition comprise from about 80 wt % to about 93.0 wt % egg white, or from about 84 wt % to about 90.0 wt % egg white, or from about 86.0 wt % to about 90.0 wt % egg white.

In an aspect, the egg white is provided as unreconstituted liquid egg white. In an aspect, the egg white is provided as powdered egg white that has been reconstituted to form a liquid egg white.

The composition further comprises a polysaccharide, such as, by way of example, and not intended to be limiting, a starch, a dextrin, a glycogen, a cellulose, a hemicellulose, a polydextrin, an inulin, a beta-glucan, a pectin, a psyllium husk mucilage, a beta-mannan, a carob, a fenugreek, a guar guam, a tara gum, a glucomannan or konjac gum, a gum acacia (arabic), a karaya, a tragacanth, a arabinoxylan (soluble), a gellan, a xanthan gum, an agar-agar, an alginate, a carrageenan, a chitin, a chitosan, and mixtures thereof.

The composition may comprise from about 5 wt % to about 29 wt % cook-up starch. In an aspect, the composition comprises from about 9 wt % to about 22 wt % cook-up starch. In an aspect, the composition comprises from about 9 wt % to about 12 wt % cook-up starch. In an aspect, the composition comprises from about 5 wt % to about 15 wt % cook-up starch. Further aspects of the composition comprise from about 5 wt % to about 12 wt % cook-up starch, from about 5 wt % to about 9 wt % cook-up starch; or about 9 wt % cook-up starch.

In an aspect, the starch used in the composition is selected from the starch derived from a vegetable. In an aspect, the starch is derived from a grain. In an aspect, the starch is derived from a material selected from corn, potato, sweet potato, cassava, rice, wheat, barley, millet, oats, sorghum, legumes, and mixtures thereof. In an aspect, the starch is unmodified starch. In an aspect, the starch is unmodified starch selected from corn starch, potato starch, rice starch, tapioca starch, and mixtures thereof.

The composition may further comprise from about 1 wt % to about 6 wt % instant starch. In an aspect, the composition comprises from about 1 wt % to about 5 wt % instant starch. In an aspect, the composition comprises from about 2 wt % to about 6 wt % instant starch. In an aspect, the composition comprises from about 2 wt % to about 4 wt % instant starch. In an aspect, the composition comprises from about 2.5 wt % to about 3 wt % instant starch. In an aspect, the composition comprises from about 3 wt % to about 4 wt % instant starch. Further aspects of the composition comprise about 2 wt % to about 3 wt % instant starch, or from about 2 to 2.5 wt % instant starch, or about 3 wt % instant starch.

For purposes of the present disclosure, an “instant starch” may be a pregelatinized starch. Pregelatinized starch was used in Examples 1 to 5. However, the instant starch may not be a pregelatinized starch. The instant starch can be either a modified or native form of any of those starches of a grade suitable for food use as defined in the regulations governing food additives. The source of the pregelatinized starch may in an aspect be any one or combination of arrowroot, barley, corn, waxy maize, pea, potato, rice, waxy rice, sorghum, waxy sorghum, tapioca and wheat starch. The instant starch helps to provide viscosity in the composition.

The composition may comprise from about 0.01 wt % to about 0.6 wt % xanthan gum. In an aspect, the composition comprises from about 0.02 wt % to about 0.55 wt % xanthan gum. In an aspect, the composition comprises from about 0.03 wt % to about 0.5 wt % xanthan gum. In an aspect, the composition comprises from about 0.04 wt % to about 0.45 wt % xanthan gum. In an aspect, the composition comprises from about 0.05 wt % to about 0.4 wt % xanthan gum. In an aspect, the composition comprises from about 0.2 wt % to about 0.3 wt % xanthan gum.

The baked snack food product in an aspect may comprise additional added ingredients, such as flavorants (including seasonings), salt, colorants, preservatives and other such additives appropriate for use in the snack industry.

It is of great advantage to provide food products, and particularly snack products, that are simple in ingredient content, both for ease of production and for consumer benefit. In an aspect, the composition has an ingredient declaration having no more than six ingredients. In an aspect, the composition has an ingredient declaration having no more than five ingredients. In an aspect, the composition has an ingredient declaration having no more than four ingredients. In an aspect, the composition has an ingredient declaration having no more than three ingredients. For purposes of the present disclosure, the number of ingredients in the ingredient declaration is determined by following the January 2013 Guidance for Industry: A Food Labeling Guide (6. Ingredient Lists) (available at http://www.fda.gov/Food/GuidanceRegulation/GuidanceDocumentsRegulatoryInformation/LabelingNutrition/ucm064880.htm) and controlling sections of the then in force applicable sections of United States Federal Regulations set forth in 21 CFR. It is specifically noted that this definition permits exclusion of trace amounts of ingredients, and defines an ingredient in certain aspects, such as “spice” ingredients to be a combination of substances that are technically separate in a strict chemical sense, but understood in the food technology industry to be a single ingredient.

In an aspect, the composition may optionally comprise additional protein sources, such as egg yolk, protein concentrate or isolate such as selected from the group consisting of rice protein, soy protein, whey protein or mixtures thereof.

In an aspect, the composition comprises food ingredients from additional food sources, such as fruits and nuts.

In an aspect, the composition is free of protein from sources other than egg white.

The composition is prepared by mixing the ingredients in any appropriate manner In an aspect, the dry ingredients are blended together before addition to the egg, preferably egg white, more preferably liquid egg white. In an aspect, the egg, preferably egg white, more preferably liquid egg white, is first blended under moderate conditions to avoid foaming, and the dry ingredients are added with shear mixing to provide complete mixing. In an aspect, the composition is mixed to have no more than about 10% foam by volume as determined by visual inspection using, for example, a graduated cylinder.

The composition is formulated and mixed to provide a viscosity such that the composition may be readily delivered to a baking surface in a uniform manner by a deposition process. It has been discovered that if the composition is too thin, the final product is very thin, brittle and will have irregular shapes. If the composition is too thick, the final product is hard or tough when chewing, and takes an undesirably long time to cook. In an aspect, the composition has a viscosity of from about 40 cPs to about 1400 cPs as measured using a Brookfield viscometer with a LV-4 spindle at 60 RPM or with a LV-3 spindle at 60 RPM. This viscosity range has been found to provide a composition that is readily delivered to a baking surface in a uniform manner The temperature at which the viscosity is measured ranges from about 50° F. to about 60° F., preferably about 50° F. to about 55° F., about 52° F. to about 55° F., about 50° F., about 51° F., about 52° F., about 53° F., about 54° F., or about 55° F. In an aspect, the composition has a viscosity of from about 44 cPs to about 1370 cPs at a temperature of 52° F. to 55° F. In an aspect, the composition has a viscosity of from about 40 cPs to about 600 cPs at a temperature of 52° F. to 55° F. In an aspect, the composition has a viscosity of from about 200 cPs to about 600 cPs at a temperature of 52° F. to 55° F. In an aspect, the composition has a viscosity of from about 300 cPs to about 500 cPs at a temperature of 52° F. to 55° F. In an aspect, the composition has a viscosity of from about 400 cPs to about 500 cPs at a temperature of 52° F. to 55° F. In an aspect, the composition has a viscosity of from about 40 cPs to about 500 cPs at a temperature of 52° F. to 55° F. In an aspect, the composition has a viscosity of from about 70 cPs to about 300 cPs at a temperature of 52° F. to 55° F. In an aspect, the composition has a viscosity of from about 800 cPs to about 1200 cPs at a temperature of 52° F. to 55° F. In an aspect, the composition has a viscosity of from about 800 cPs to about 1000 cPs at a temperature of 52° F. to 55° F. A further aspect of the composition comprises a viscosity of from about 200 cPs to about 1700 cPs at 50° F. using a Brookfield viscometer LV-3 spindle at 60 RPM. In a further aspect, the composition comprises a viscosity of from about 300 cPs to about 1500 cPs at 50° F., or from about 300 cPs to about 1300 cPs at 50° F., or from about 300 cPs to about 900 cPs at 50° F., or from 300 cPs to about 700 cPs at 50° F., using a Brookfield viscometer LV-3 spindle at 60 RPM. In a further aspect, the composition comprises a viscosity of from about 400 cPs to about 1300 cPs at 50° F., or from about 600 cPs to about 1300 cPs at 50° F., using a Brookfield viscometer LV-3 spindle at 60 RPM.

In addition to viscosity, the composition is formulated and mixed to provide a moisture content such that the composition is at least about 60% moisture, or at least 65% moisture, or at least 70% moisture, or at least about 75% moisture, or at least about 80% moisture, or from about 60% moisture to about 80% moisture, or from about 70% moisture to about 80% moisture, or from about 75% moisture to about 78% moisture. The moisture content is measured using a Fisher Scientific™ General Purpose Heating/Drying Oven, Model 3511FS.

The composition is then deposited on a baking surface in aliquots by any appropriate technique, such as pouring onto a surface from a vessel or pumping by gravity feed or under pressure.

In an aspect, the baking surface comprises individual containers for receiving the composition, the containers having a defined volume and configured to provide the final baked snack food product with a defined shape in longest two dimensions. In an aspect, the baking surface is an elongated sheet comprising a plurality of depressions forming individual containers for receiving the composition. In an aspect, the baking surface comprises one or more containers having a defined volume in a two dimensional shape selected from the group consisting of a rectangular shape, triangular shape, circular shape, ellipsoidal shape, or a combination thereof. In an aspect, the baking surface has a textured surface to impart a surface structure, or symbol on the face of the final baked snack food product.

In an aspect, the baked snack food product has a two dimensional shape in the non-thickness dimensions generally corresponding to shapes selected from the group consisting of a rectangular shape, triangular shape, circular shape, ellipsoidal shape, or a combination thereof. In an aspect, the baked snack food product has a surface structure or symbol on the face of the final baked snack food product.

In an aspect, the surface is a baking sheet or conveyor surface conveyed through an oven. In an aspect, the baking surface is a flat surface having a low surface energy to facilitate spreading out of the composition before and during cooking. In an aspect, the baking surface also provides some surface tension to allow the composition not to spread as much before and during cooking, thus allowing for controlling thickness of the baked food product. In an aspect, the baking surface is a parchment sheet. In an aspect, the baking surface is a greased or oiled parchment sheet. In an aspect, the baking surface is a silicone sheet. In an aspect, the baking surface is a metal sheet treated or coated with a non-stick surface, such as a Teflon® coated surface. In an aspect, the baking surface does not contribute oil to the final baked snack food product. In an aspect, the baking surface allows the final baked snack food product to release from the sheet after baking and/or drying.

The composition is then baked to a moisture content from about 40% to about 85%, or from about 40% to about 80%, or from about 50% to about 80%, or from about 60% to about 75%, or from about 60% to about 70%. In Tables 3 to 5, this moisture content before baking is referred to as “Moisture—Intermediate.”

The composition is then baked to a baked snack food product thickness of from about 0.03 inch to about 0.09 inch, from about 0.03 inch to about 0.06 inch, or from about 0.03 inch to about 0.04 inch, or from about 0.05 inch to about 0.06 inch.

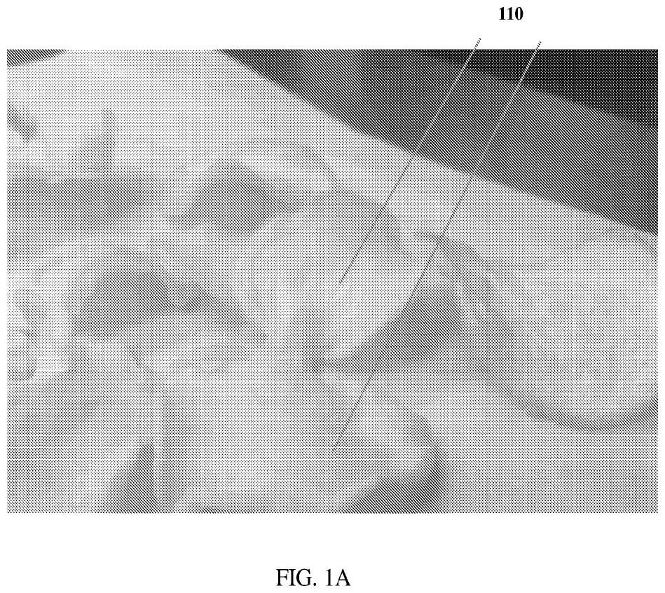

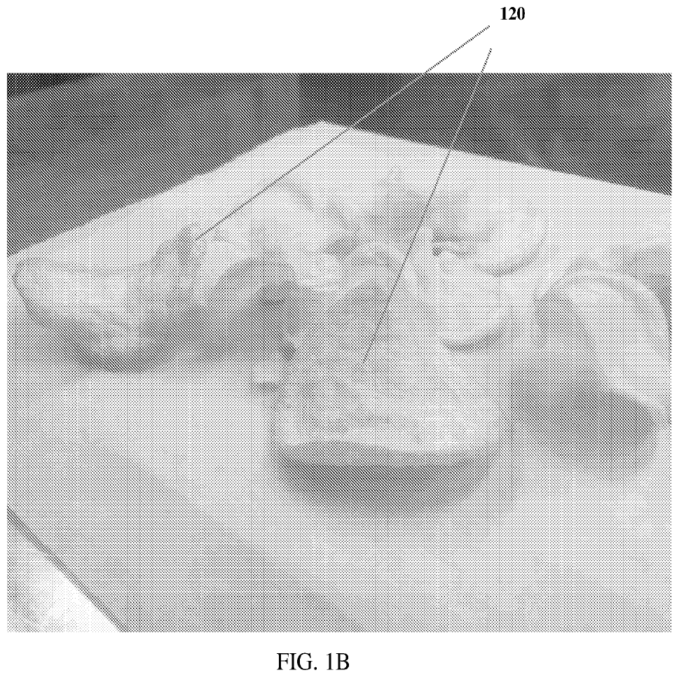

The baked snack food products in FIGS. 1-5 are made from about 87 wt % to about 88 wt % egg white, from about 2.5 wt % to about 3 wt % instant starch, from about 8 wt % to about 9 wt % cook-up starch, and from about 0.4 wt % to about 0.5 wt % cream of tartar. FIG. 1A is a photograph showing a perspective view of baked snack food products 110. FIG. 1B is a photograph showing a perspective view of baked snack food products 120. FIG. 1A (“dense”) and FIG. 1B (“light”), when compared, shows a difference in density, which affects texture. The baked snack food products in FIG. 1B have a more bubbling, light appearance (similar to a conventional potato chip) compared to the more leathery, dense baked snack food products (similar to a kettle chip) in FIG. 1A.

During baking, portions of the product may be expanded or “puffed” 120 relative to others. These expanded portions may be due to uneven thickness of the composition when deposited on the baking surface, entrained air, concentration of water in a certain region of the composition, or other causes. The desired final baked snack food product 120 is a more expanded and puffed or bubbling appearance. However, the baked snack food product 110 is a predominantly uniform thickness that is dense and not expanded, and is also an acceptable baked snack food product from a consumer perspective. Expanded portions are readily determined by visual inspection, viewing from the top of the product.

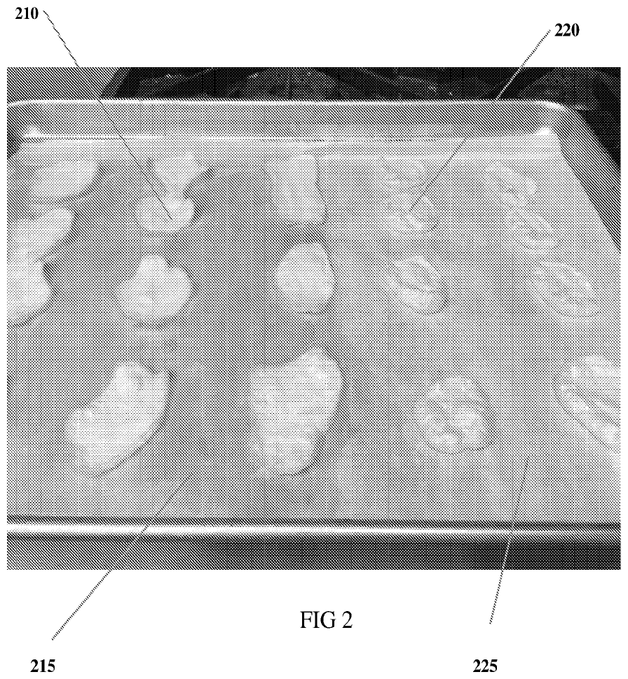

FIG. 2 is a photograph showing a perspective view of a comparison of baked snack food products that have just been cooked on a parchment sheet. The left portion of the parchment sheet 215 has been oiled, and therefore has a lower surface energy than untreated parchment sheet portion 225. Baked snack food products 210 that are cooked on this low surface energy have fewer expanded portions than baked snack food products 220 that are cooked on untreated parchment sheets 225.

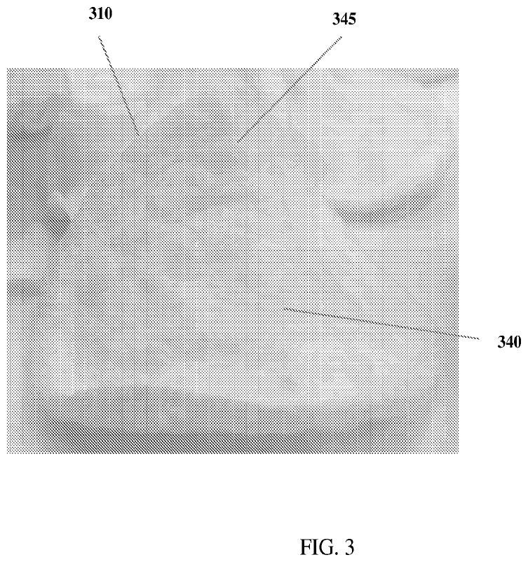

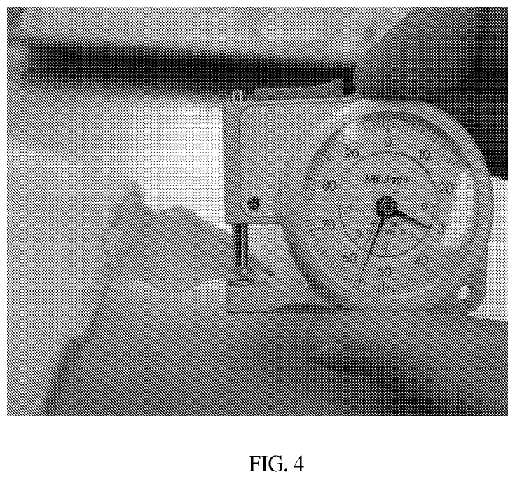

FIG. 3 is a photograph showing a top enlarged view of a baked snack food product 310, having clearly visible expanded portion 345 and non-expanded portion 340. In an aspect, at least 20% of the area of the baked snack food product is expanded as determined by visual inspection viewing from the top of the product. In an aspect, at least 25% of the area of the baked snack food product is expanded as determined by visual inspection viewing from the top of the product. In an aspect, at least 30% of the area of the baked snack food product is expanded as determined by visual inspection viewing from the top of the product. Final product thickness is evaluated by use of a thickness gauge, and is the average of three measurements taken at points interior relative to the perimeter of the chip and not at an expanded portions, as shown in FIG. 4. An example of a suitable, commercially available thickness gauge for measurement of the thickness of the chips is available from Mitutoyo Corporation.

The composition is baked in an oven for time and temperature suitable for cooking the product to desired doneness. In an aspect, the product is baked until it has a pale yellow or a lightly tan or creme appearance. In an aspect, the product is baked at an oven temperature of from about 300° F. to about 450° F. In an aspect, the product is baked at an oven temperature of from about 325° F. to about 400° F. In an aspect, the product is baked at an oven temperature of from about 350° F. to about 375° F. In another aspect, the product is baked at an oven temperature of about 350° F.

In an aspect, the composition is baked in a continuous oven. In an aspect, the composition is baked in an oven that provides steam as well as heat. It has been found that baking under humid conditions beneficially reduces the amount of expansion (i.e. “puffing”) and assists in providing a baked snack food product that has a substantially uniform thickness. In an aspect, the composition is baked in an oven that provides steam as well as heat for a first period of time to bake the product in a moist environment, and then the product is transferred to a dry heat oven to complete cooking and dry the product to a final moisture content of about 10% or less.

In an aspect, the final moisture content of the baked snack product is from about 2% to about 10% (“Moisture—Final” in Tables 3 to 5). In an aspect, the final moisture content of the baked snack product is from about 2% to about 8%. In an aspect, the final moisture content of the baked snack product is from about 2% to about 5%. In an aspect, the final moisture content of the baked snack product is from about 2% to about 4%. It has been found that if the final moisture content is too high, the baked snack food product is chewy and can be almost “leathery” in texture. Conversely, if the final moisture content is too low, the baked snack food product is too hard in texture.

In an aspect, the dry heat oven is at an oven temperature of from about 100° F. to about 250° F. In an aspect, the composition is dried in a dry heat oven at an oven temperature of from about 100° F. to about 250° F. for from about 15 to about 20 minutes. In an aspect, the dry heat oven is a convection oven. A dryer, used for the purpose of drying down semi-moist products, passes hot air over the composition in trays at temperatures of about 150° F. to about 300° F., or from about 200° F. to about 250° F.

The baked snack food product may be evaluated to determine its fragility or toughness by measuring the amount of force required to break a product straddling a holder by a rounded probe. The skilled artisan can quantify the force on any giving testing instrument to balance parameters of recipe, cook time, product thickness, and so forth, to obtain a standard product that does not break under light handling (i.e. too fragile) or is not excessively tough so that it is chewy or hard to break.

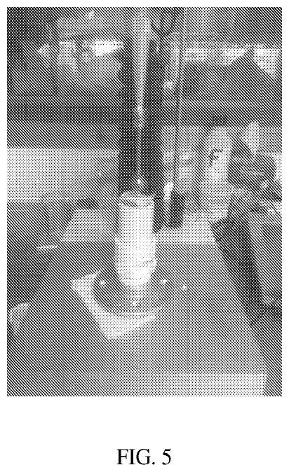

For purposes of the present disclosure, a Fracturability Value is determined by measurement of a product using a Texture Technologies Texture Analyzer (TA-XT2 model) measured at a probe speed of 2 mm/seconds to determine the force required to fracture a chip supported by a sample holder at contact points that are 2 inches apart, such as shown in FIG. 5. The baked snack food product in an aspect exhibits a Fracturability Value of from about 150 to about 300 grams of force. The baked snack food product in an aspect exhibits a Fracturability Value of from about 200 to about 2500 grams of force. It has been found that if the Fracturability Value of the baked snack food product is above 300 grams of force the chips become quite tough and hard to chew. If the Fracturability Value of the baked snack food product is below about 150 grams of force, the chips become fragile or brittle.

In an aspect the product has a density from about 0.03 g/cm³ to about 0.06 g/cm³. In an aspect the product has a density of from about 0.04 g/cm³ to about 0.05 g/cm³.

In an aspect, a baked snack food product is provided having a pre-cooked composition of from about 75 wt % to about 99.5 wt % egg white; a polysaccharide selected from the group comprising instant starch, cook-up starch, xanthan gum, and mixtures thereof, wherein the instant starch is from about 2 wt % to about 6 wt %, the cook-up starch is from about 5 wt % to about 29 wt %, and the xanthan gum is from about 0.05 wt % to about 0.4 wt %; a moisture content of from about 2 wt % to about 10 wt %; and a thickness of from about 0.03 inch to about 0.09 inch.

In an aspect, a baked snack food product is provided having a pre-cooked composition of from about 75 wt % to about 95 wt % egg white, from about 5 wt % to about 15 wt % of cook-up starch, and from about 2 wt % to about 6 wt % of instant starch; a moisture content of from about 2 wt % to about 10 wt %; and a thickness of from about 0.03 inch to about 0.06 inch.

In an aspect, a baked snack food product is provided having a pre-cooked composition of from about 86 wt % to about 90 wt % egg white, from about 5 wt % to about 9 wt % cook-up starch, and from about 2 wt % to about 4 wt % of instant starch; a moisture content of from about 2 wt % to about 5 wt %; and a thickness of from about 0.03 inch to about 0.06 inch.

### EXAMPLES

Total solids content is a measure of the amount of material remaining after all the water has been evaporated. The liquid solids (%) represents total solids of the liquid mixture comprised of liquid egg white, starch or other polysaccharide(s) and cream of tartar (viscosities are measured at the liquid solids %); the intermediate solids (%) represents total solids measured of the composition after initial baking and prior to drying; and final solids (%) represents total solids of the final dried product.

Intermediate Solids (%) is a measurement of the solids values of the intermediate baked product in the egg chip making process (i.e., after baking to cook the egg white and before drying). The intermediate solids is determined by an oven drying method. Five (5) grams of a sample are added to a predried dish (i.e., a dish that has been held in the oven at 100° C. for 48 hours ahead of testing) and its weight recorded, then placed into the drying oven for 18 hours to dry and, after 18 hours, its weight is recorded. Final determination is calculated by subtracting the weight of the dish from the gross final weight (sample plus dish) and dividing by the net original weight of the sample to determine the percent solids.

A Brookfield viscometer with a LV-4 spindle or a LV-3 spindle at 60 RPM is used to determine the viscosity of samples described in Examples 1 to 5 at a temperature of about 50° F., or about 52° F. or from about 52° F. to 55° F., and at the percent solids of the Liquid Solids set forth in Tables 2 to 5.

The composition in Examples 1 to 5 was baked at about 350° F. for about two minutes in a combination oven that provides steam and heat, and then the product was transferred to a dry heat oven (e.g., a standard conventional oven) at a temperature of about 200° F. to about 250° F., more preferably about 200° F., to dry the product to a final moisture content of about 10% or less, preferably about 2% to about 8%, more preferably about 2% to about 5%.

### Example 1

Various baked snack food products were made using the composition of a liquid egg white and a mixture of instant starch and cook-up starch. Salt and cream of tartar were also added to the composition. As shown in Table 1, four compositions were tested using liquid Egg White at 75 wt %, 80 wt %, 85 wt %, and 88 wt % (control) with Cook-Up Starch at 22 wt %, 17 wt %, 12 wt %, and 9 wt % (control) and Instant Starch at 2 wt %, respectively. Liquid egg white at 88 wt % is designated as the control because it has been found to produce a desirable finished product.

TABLE 1
Baked snack food products made with liquid egg white
and a mixture of instant and cooked-up starches

| | Egg level variations | | | | | | | |
|---|---|---|---|---|---|---|---|---|
| | 1 | | 2 | | 3 | | 4 | |
| | Batch Size: 500.00 | | | | | | | |
| | Control | | 75% Egg | | 80% Egg | | 85% Egg | |
| | (88% Egg white) | | White | | White | | White | |
| | | Amount | | Amount | | Amount | | Amount |
| Ingredients | Percent | (g) | Percent | (g) | Percent | (g) | Percent | (g) |
| Liquid Egg | 88.06% | 440.29 | 75.00% | 375.00 | 80.00% | 400.00 | 85.00% | 425.00 |
| Whites | | | | | | | | |
| Cook Up | 9.00% | 45.00 | 22.06% | 110.30 | 17.06% | 85.30 | 12.06% | 60.30 |
| Starch, | | | | | | | | |
| Polartex | | | | | | | | |
| 06735 | | | | | | | | |
| Instant | 2.00% | 10.00 | 2.00% | 10.00 | 2.00% | 10.00 | 2.00% | 10.00 |
| Starch, | | | | | | | | |
| Stabitex | | | | | | | | |
| 12624 | | | | | | | | |
| Cream of | 0.47% | 2.36 | 0.47% | 2.35 | 0.47% | 2.35 | 0.47% | 2.35 |
| Tartar | | | | | | | | |
| Salt | 0.47% | 2.36 | 0.47% | 2.35 | 0.47% | 2.35 | 0.47% | 2.35 |

Using a LV-4 Spindle at 60 RPM, the viscosities of the baked snack food products ranged from about 400 to about 970 cPs at a temperature of from about 52° F. to about 55° F. Sample 1 had a viscosity of 540 cPS at 52° F.; Sample 2 had a viscosity of 970 cPs also at 52° F. The viscosity of Sample 3 at 55° F. was 700 cPs and the viscosity of Sample 4 at 53° F. was 410 cPs. The thickness of the baked snack food products ranged from about 0.03 inch to about 0.06 inch. The appearance and/or texture of the baked snack food products are similar in nature to a potato chip having a pleasantly crisp texture, some variation of less dense and more dense portions and light in color.

### Example 2

Various baked snack food products were made using liquid egg white and a polysaccharide of xanthan gum, cook-up starch, instant starch, or a mixture of instant starch and cook-up starch. Table 2 shows the various wt % of each of the polysaccharides (Xanthan Gum 0.05 wt %, 0.1 wt %, 0.2 wt %, 0.3 wt %, and 0.4 wt % with Liquid Egg White 99.95 wt %, 99.9 wt %, 99.8 wt %, 99.7 wt %, and 99.6 wt %; Cook-Up Starch 5 wt %, 8 wt %, 14 wt %, and 15 wt % with Liquid Egg White 95 wt %, 92 wt %, 86 wt % and 85 wt %; Instant Starch 2 wt %, 5 wt %, and 6 wt % with Liquid Egg White 98 wt %, 95 wt %, and 94 wt %; and a mixture of Cook-Up Starch 9 wt % and Instant Starch 2 wt % with Liquid Egg White 88 wt %.

TABLE 2
Baked snack food products made with egg white and certain polysaccharides

| | Xanthan | | | | | Cook Up Starch | | | |
|---|---|---|---|---|---|---|---|---|---|
| | 0.05% | 0.10% | 0.20% | 0.30% | 0.40% | 5% | 8% | 14% | 15% |
| Liquid | 12.345 | 11.86 | 11.715 | 11.93 | 11.825 | 14.61 | 16.34 | 18.96 | 25.06 |
| Solids (%) | | | | | | | | | |
| Intermediate | 42.03 | | 18.35 | | 20.53 | 35.32 | | | 41 |
| Solids (%) | | | | | | | | | |
| Final | 90.63 | | | | 91.56 | 90.67 | | | 90.51 |
| Solids (%) | | | | | | | | | |
| Viscosity | 90 | 78 | 133 | 241 | 267 | 44 | 66 | 62 | 54 |
| (cPs) | | | | | | | | | |
| Thickness | 0.0443 | 0.0547 | 0.0522 | 0.0671 | 0.0871 | 0.0402 | 0.0437 | 0.0352 | 0.0342 |
| (in) | | | | | | | | | |

| | Instant Starch | | | Instant & Cook Up | | |
|---|---|---|---|---|---|---|
| | 2% | 5% | 6% | Batch 1 | Batch 2 | Batch 3 |
| Liquid | 13.15 | 18.52 | 17.17 | | | |
| Solids (%) | | | | | | |
| Intermediate | 56.56 | | 29 | 34.90 | 43.61 | |
| Solids (%) | | | | | | |
| Final | 90.87 | | 67.24 | 90.82 | 95.56 | |
| Solids (%) | | | | | | |
| Viscosity | 96 | 483 | 1370 | 200 | 332 | 526 |
| (cPs) | | | | | | |
| Thickness | 0.0509 | 0.0759 | 0.0835 | 0.0463 | | |
| (in) | | | | | | |

Using a LV-3 Spindle at 60 RPM, the viscosities of the baked snack food products ranged from about 44 cPs to about 1370 cPs. The thickness of the baked snack food products ranged from about 0.03 inch to about 0.09 inch, preferably about 0.03 inch to about 0.06 inch. The composition of 88% liquid egg white, 9% cook-up starch, and 2% instant starch had a viscosity of about 200 cPs to about 530 cPs and the baked snack food product had a thickness of 0.05 inch. The appearance and/or texture of the baked snack food products ranged from light to dense, and as further described in Paragraphs [0044] and [0046].

### Example 3

### Baked Snack Food Products made with Liquid Egg White and a Mixture of Instant Starch and 5% Cook-Up Starch.

Various baked snack food products were made using the composition of a liquid egg white and a mixture of 5% cooked-up starch and various amounts of instant starch. Salt was also added to the composition. As shown in Table 3A, four compositions were tested using liquid Egg White at 92.5%, 92.0%, 91.5%, 90.5%, and 88.5% with Cook-Up Starch at 5% and Instant Starch at 2.0%, 2.5%, 3.0%, 4.0%, and 6.0%.

TABLE 3A
Formulation

| | Starch variations | | | | | | | | | |
|---|---|---|---|---|---|---|---|---|---|---|
| | 5% CU, 2% | | 5% CU, 2.5% | | 5% CU, 3% | | 5% CU, 4% | | 5% CU, 6% | |
| | Instant | | Instant | | Instant | | Instant | | Instant | |
| | | AMOUNT | | AMOUNT | | AMOUNT | | AMOUNT | | AMOUNT |
| INGREDIENTS | PERCENT | (g) | PERCENT | (g) | PERCENT | (g) | PERCENT | (g) | PERCENT | (g) |
| Liquid Egg | 92.53% | 462.65 | 92.03% | 460.15 | 91.53% | 457.65 | 90.53% | 452.65 | 88.53% | 442.65 |
| Whites | | | | | | | | | | |
| Cook up | 5.00% | 25.00 | 5.00% | 25.00 | 5.00% | 25.00 | 5.00% | 25.00 | 5.00% | 25.00 |
| Starch | | | | | | | | | | |
| Polartex | | | | | | | | | | |
| 06735 | | | | | | | | | | |
| Instant | 2.00% | 10.00 | 2.50% | 12.50 | 3.00% | 15.00 | 4.00% | 20.00 | 6.00% | 30.00 |
| Starch, | | | | | | | | | | |
| Stabitex | | | | | | | | | | |
| 12624 | | | | | | | | | | |
| Salt | 0.47% | 2.35 | 0.47% | 2.35 | 0.47% | 2.35 | 0.47% | 2.35 | 0.47% | 2.35 |
| | 100.00% | 500.00 | 100.00% | 500.00 | 100.00% | 500.00 | 100.00% | 500.00 | 100.00% | 500.00 |

Using a LV-3 Spindle at 60 RPM at 50° F., the viscosities of the composition of egg white, instant starch, and cook up starch were in a range from about 400 cPs to about 1700 cPs, or from about 430 cPs to about 1660 cPs, as shown in Table 3B. The composition of 92.5% egg white, 5% Cook-Up Starch and 2% Instant Starch (Sample A) yielded a viscosity of 458 cPs; the composition of 92% egg white, 5% Cook-Up Starch and 2.5% Instant Starch (Sample B) was 434 cPs; the composition of 91.5% egg white, 5% Cook-Up Starch and 3% Instant Starch (Sample C) was 682 cPs; and the composition of 90.5% egg white, 5% Cook-Up Starch and 4% Instant Starch (Sample D) was 1658 cPs. The moisture of the intermediate composition was in a range from about 70.0% to about 80.0%, or from about 70.0% to about 76.0%. Sample A had an intermediate moisture of 70.44%; Sample B had 73.53%; Sample C had 73.43%; and Sample D had75.74% (each Sample is an average of two samples). The thickness of the baked snack food products (i.e., finished product) was in a range from about 0.04 inch to about 0.07 inch, preferably about 0.05 inch to about 0.06 inch. Sample A had a thickness of 0.047 inch; Sample B had 0.053 inch; Sample C had 0.054 inch; and Sample D had 0.063 inch (each Sample is the average of 10 samples). The moisture of the final baked snack food products was in a range from about 4.0% to about 8.0%. Sample A had a moisture of 7.4%; Sample B had 4.19%; Sample C had 4.38%; and Sample D had 4.69% (each Sample is an average of two samples).

TABLE 3B
Viscosity, Thickness, and Moisture

| | Cook Up Starch 5.0% | | | |
|---|---|---|---|---|
| | Instant starch | | | |
| | 2.00% (A) | 2.50% (B) | 3.00% (C) | 4.00% (D) |
| Egg white | 92.53% | 92.03% | 91.53% | 90.53% |
| Liquid Solids (%) | 18.31% | 19.15% | 19.75% | 20.31% |
| Intermediate Solids (%) | 29.56% | 26.47% | 26.57% | 24.26% |
| Final Solids (%) | 92.60% | 95.81% | 95.62% | 95.31% |
| Viscosity (cPs) | 458 | 434 | 682 | 1658 |
| pH @ 50° F. | 8.31 | 8.42 | 8.57 | 8.57 |
| Thickness (in) | 0.0472 | 0.0531 | 0.0538 | 0.0632 |
| Moisture - Final (%) | 7.4 | 4.19 | 4.38 | 4.69 |
| Moisture - Intermediate | 70.44 | 73.53 | 73.43 | 75.74 |
| (%) | | | | |

### Example 4

### Baked Snack Food Products made with Liquid Egg White and a Mixture of Instant Starch and 9% Cook-Up Starch

Various baked snack food products were made using the composition of a liquid egg white and a mixture of 9% cooked-up starch and various amounts of instant starch. Salt was also added to the composition. As shown in Table 4A, four compositions were tested using liquid Egg White at 88.53%, 88.03%, 87.53%, 86.53%, and 84.53% with Cook-Up Starch at 9% and Instant Starch at 2.0%, 2.5%, 3.0%, 4.0%, and 6.0%

TABLE 4A
Formulations

| | Starch Variations | | | | | | | | | |
|---|---|---|---|---|---|---|---|---|---|---|
| | 9% CU, 2% | | 9% CU, 2.5% | | 9% CU, 3% | | 9% CU, 4% | | 9% CU, 6% | |
| | Instant | | Instant | | Instant | | Instant | | Instant | |
| | | AMOUNT | | AMOUNT | | AMOUNT | | AMOUNT | | AMOUNT |
| INGREDIENTS | PERCENT | (g) | PERCENT | (g) | PERCENT | (g) | PERCENT | (g) | PERCENT | (g) |
| Liquid Egg | 88.53% | 442.65 | 88.03% | 440.15 | 87.53% | 437.65 | 86.53% | 432.65 | 84.53% | 422.65 |
| Whites | | | | | | | | | | |
| Cook up | 9.00% | 45.00 | 9.00% | 45.00 | 9.00% | 45.00 | 9.00% | 45.00 | 9.00% | 45.00 |
| Starch | | | | | | | | | | |
| Polartex | | | | | | | | | | |
| 06735 | | | | | | | | | | |
| Instant | 2.00% | 10.00 | 2.50% | 12.50 | 3.00% | 15.00 | 4.00% | 20.00 | 6.00% | 30.00 |
| Starch, | | | | | | | | | | |
| Stabitex | | | | | | | | | | |
| 12624 | | | | | | | | | | |
| Salt | 0.47% | 2.35 | 0.47% | 2.35 | 0.47% | 2.35 | 0.47% | 2.35 | 0.47% | 2.35 |
| | 100.00% | 500.00 | 100.00% | 500.00 | 100.00% | 500.00 | 100.00% | 500.00 | 100.00% | 500.00 |

TABLE 4B
Viscosity, Thickness, and Moisture

| | Cook Up Starch 9.0% | | | |
|---|---|---|---|---|
| | Instant starch | | | |
| | 2.00% (A) | 2.50% (B) | 3.00% (C) | 4.00% (D) |
| Egg white | 88.53% | 88.03% | 87.53% | 86.53% |
| Liquid Solids (%) | 20.95% | 21.76% | 23.04% | 22.78% |
| Intermediate Solids (%) | 31.08% | 31.33% | 27.88% | 30.88% |
| Final Solids (%) | 96.38% | 97.38% | 97.38% | 97.61% |
| Viscosity (cPs) | 276 | 396 | 668 | 1306 |
| pH @ 50° F. | 8.68 | 8.73 | 8.76 | 8.74 |
| Thickness (in) | 0.0311 | 0.0523 | 0.0532 | 0.0596 |
| Moisture - Final (%) | 3.62 | 2.62 | 2.62 | 2.39 |
| Moisture - Intermediate | 68.93 | 68.67 | 72.13 | 69.12 |
| (%) | | | | |

Using a LV-3 Spindle at 60 RPM and a temperature of 50° F., the viscosities of the composition of egg white, instant starch, and cook up starch were in a range from about 200 cPs to about 1300 cPs, preferably from about 400 cPs to about 1300 cPs, as shown in Table 4B. The composition of 88.5% egg white, 5% Cook-Up Starch and 2% Instant Starch (Sample A) yielded a viscosity of 276 cPs; the composition of 88.0% egg white, 5% Cook-Up Starch and 2.5% Instant Starch (Sample B) was 396 cPs; the composition of 87.5% egg white, 5% Cook-Up Starch and 3% Instant Starch (Sample C) was 668 cPs; and the composition of 86.5% egg white, 5% Cook-Up Starch and 4% Instant Starch (Sample D) was 1306 cPs. The moisture of the intermediate composition was in a range from about 65.0% to about 80.0%, or from about 68.0% to about 72.0%. Sample A had an intermediate moisture of 68.93%; Sample B was 68.67%; Sample C was 72.13%; and Sample D was 69.12% (each Sample is an average of two samples). The thickness of the baked snack food products (i.e., finished product) was in the range of from about 0.03 inch to about 0.06 inch. Sample A had a thickness of 0.031 inch; Sample B was 0.052 inch; Sample C was 0.053 inch; and Sample D was 0.060 inch (each Sample is the average of 10 samples). The moisture of the final baked snack food products ranged from about 2.0% to about 4.0%. Sample A had a moisture of 3.62%; Sample B was 2.62%; Sample C was 2.62%; and Sample D was 2.39% (each Sample is an average of two samples).

### Example 5

### Baked Snack Food Products made with Liquid Egg White and a Mixture of Instant Starch and Cook-Up Starch

TABLE 5A
Formulations

| | Starch Variations | | | | | | | |
|---|---|---|---|---|---|---|---|---|
| | 3% Instant, | | 3% Instant, | | 4% Instant, | | 4% Instant, | |
| | 8% CU (A) | | 15% CU (B) | | 8% CU (C) | | 15% CU (D) | |
| | | AMOUNT | | AMOUNT | | AMOUNT | | AMOUNT |
| INGREDIENTS | PERCENT | (g) | PERCENT | (g) | PERCENT | (g) | PERCENT | (g) |
| Liquid Egg | 88.53 | 442.65 | 81.53 | 407.65 | 87.53 | 437.65 | 86.53% | 432.65 |
| Whites | | | | | | | | |
| Cook up | 8.00 | 40.00 | 15.00 | 75.00 | 8.00 | 40.00 | 9.00% | 45.00 |
| Starch | | | | | | | | |
| Polartex | | | | | | | | |
| 06735 | | | | | | | | |
| Instant | 3.00 | 15.00 | 3.00 | 15.00 | 4.00 | 20.00 | 4.00% | 20.00 |
| Starch, | | | | | | | | |
| Stabitex | | | | | | | | |
| 12624 | | | | | | | | |
| Salt | 0.47% | 2.35 | 0.47% | 2.35 | 0.47% | 2.35 | 0.47% | 2.35 |
| | 100.00% | 500.00 | 100.00% | 500.00 | 100.00% | 500.00 | 100.00% | 500.00 |

Various baked snack food products were made using the composition of a liquid egg white and a mixture of either 8% or 15% cooked-up starch and either 3% or 4% of instant starch. Salt was also added to the composition. As shown in Table 5A, four compositions were tested using liquid Egg White at 88.5%, 81.5%, 87.5%, 80.5 with 3% Instant Starch and 8% Cook-Up Starch (Sample A); or 3% Instant Starch and 15% Cook-Up Starch (Sample B); or 4% Instant Starch and 8% Cook-Up Starch (Sample C); or 4% Instant Starch and 15% Cook-Up Starch (Sample D).

Using a LV-3 Spindle at 60 RPM and a temperature of 52° F., the viscosities of the composition of egg white, instant starch, and cook up starch were in a range from about 700 cPs to about 1500 cPs, or from about 800 cPs to about 1500 cPs, as shown in Table 5B. The composition of 88.5% liquid egg white, 3% Instant Starch and 8% Cook-Up Starch (Sample A1) yielded a viscosity of 712 cPs; the composition of 81.5% egg white, 15% Cook-Up Starch and 3% Instant Starch (Sample A2) was 856 cPs; the composition of 87.5% egg white, 8% Cook-Up Starch and 4% Instant Starch (Sample B1) was 1454 cPs; and the composition of 80.5% egg white, 15% Cook-Up Starch and 4% Instant Starch (Sample B2) was 2370 cPs (using a LV-4 Spindle). The moisture of the intermediate composition was in a range from about 60.0% to about 70.0%, or from about 64% to about 70%. Sample Al had an intermediate moisture of 67.14%; Sample A2 was 64.09%; Sample B1 was 69.43%; and Sample B2 was 63.78% (each Sample is the average of 2 samples). The thickness of the baked snack food products (i.e., finished product) was in a range from about 0.04 inch to about 0.07 inch, preferably about 0.05 inch to about 0.06 inch. Sample Al had a thickness of 0.05 inch; Sample A2 was 0.047 inch; Sample B1 was 0.059 inch; and Sample B2 was 0.063 inch (each Sample is the average of 10 samples). The moisture of the final baked snack food products was in a range from about 5.0% to about 8.0%. Sample Al had a moisture of 5.33%; Sample A2 was 5.17%; Sample B1 was 7.48%; and Sample B2 7.73 (each Sample is the average of 2 samples).

TABLE 5B
Viscosity, Thickness, and Moisture

| | 3% Instant Starch (A) | | 4% Instant Starch (B) | |
|---|---|---|---|---|
| | Cook up Starch | | | |
| | 8.00% (A1) | 15.00% (A2) | 8.00% (B1) | 15.00% (B2) |
| Egg White | 88.53% | 81.53% | 87.53% | 80.53% |
| Liquid Solids (%) | 22.10% | 26.66% | 22.69% | 27.70% |
| Intermediate Solids (%) | 32.86% | 35.91% | 30.57% | 36.22% |
| Final Solids (%) | 94.67% | 94.83% | 91.99% | 93.26% |
| Viscosity (cPs) | 712 | 856 | 1454 | 2370* |
| pH @ 52 deg F. | 8.67 | 8.72 | 8.75 | 8.75 |
| Thickness (in) | 0.0502 | 0.0473 | 0.0594 | 0.0633 |
| Moisture - Final (%) | 5.33 | 5.17 | 7.48 | 7.73 |
| Moist - Intermediate | 67.14 | 64.09 | 69.43 | 63.78 |
| (%) | | | | |

*Spindle 4, 60 RPM, 52 deg F.

In Examples 3, 4, and 5, the baked snack food product was pale to lightly brown in color. The shape was irregular and, while generally flat, the product had curled edges and surfaces. The baked snack food product could be mistaken for a small potato chip from a visual standpoint.

It will be understood that all the above product features, such as ingredient selection, physical characteristics and product configurations are expressly contemplated to apply to the baked snack food product described immediately above.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The present disclosure is not limited to the exact details shown and described, for variations obvious to one skilled in the art will be included within the present disclosure defined by the claims.

1. A method of making a baked snack food product comprising:
a) preparation of a composition comprising
i) an egg white from about 75 wt % to about 95 wt %;
ii) cook-up starch from about 5 wt % to about 15 wt %; and
iii) instant starch from about 2 wt % to about 6 wt %,
wherein the composition has a viscosity of from about 200 cPs to about 1700 cPs at about 50° F.;
b) depositing the composition on a baking surface;
c) baking the composition to a moisture content from about 40% to about 80%; and,
d) drying the composition to a moisture content from about 2% to about 10%.

2. The method of claim 1, wherein after the drying step, the thickness of the composition is from about 0.03 inch to about 0.09 inch, preferably 0.03 inch to about 0.06 inch.

3. The method of claim 1, wherein the composition comprises from about 80 wt % to about 93.0 wt % egg white, from about 84 wt % to about 90.0 wt % egg white, or from about 86.0 wt % to about 90.0 wt % egg white.

4. The method of claim 1, wherein the egg white is unreconstituted liquid egg white.

5. The method of claim 1, wherein the cook-up starch is unmodified starch selected from rice starch, tapioca starch, and mixtures thereof.

6. The method of claim 1, wherein the composition has a viscosity of from about 300 cPs to about 1300 cPs at 50° F., from about 400 cPs to about 1300 cPs at 50° F., or from about 600 cPs to about 1300 cPs at 50° F.

7. The method of 1, wherein the composition comprises from about 5 wt % to about 12 wt % cook-up starch, from about 5 wt % to about 9 wt % cook-up starch, or about 9 wt % cook-up starch.

8. The method of claim 1, wherein the cook-up starch is an unmodified starch selected from corn starch, potato starch, rice starch, tapioca starch, and mixtures thereof.

9. The method of claim 1, wherein the composition comprises from about from about 2 to about 4 wt % instant starch, from about 2 to about 3 wt % instant starch, from about 2 to 2.5 wt % instant starch, from about 2.5 to about 3 wt % instant starch, or about 3%.

10. The method of claim 1, wherein the instant starch is selected from the group consisting of arrowroot, barley, corn, waxy maize, pea, potato, rice, waxy rice, sorghum, waxy sorghum, tapioca and wheat starch.

11. The method of claim 1, wherein the composition is baked to a moisture content from about 60% to about 80%, from about 60% to about 75%, or from about 60% to about 70%.

12. The method of claim 1, wherein the baked snack food product further comprises additional added ingredients selected from the group consisting of flavorants, salt, colorants, preservatives, and combinations thereof.

13. The method of claim 1, wherein the baked snack food product has an ingredient declaration having no more than six ingredients, or having no more than three ingredients.

14. The method of claim 1, wherein the composition is free of protein from sources other than egg white.

15. The method of claim 2, wherein the baked snack food product has a thickness of from about 0.03 inch to about 0.04 inch.

16-18. (canceled)

19. The method of claim 1, wherein no more than about 20 percent of the area of the baked snack food product is expanded, or wherein no more than about 15 percent of the area of the baked snack food product is expanded, or wherein no more than about 10 percent of the area of the baked snack food product is expanded.

20. The method of claim 1, wherein the final moisture content of the baked snack food product is from about 2% to about 10%, from about 2% to about 8%, from about 2% to about 5%, from about 2% to about 4%, from about 3% to about 8%, or from about 3% to about 5%.

21. The method of claim 1, wherein the baked snack food product exhibits a Fracturability Value of from about 150 to about 300 grams of force.

22. The method of claim 1, wherein the baked snack food product has a density of from about 0.03 g/cm³ to about 0.06 g/cm³, or from about 0.04 g/cm³ to about 0.05 g/cm³.

23. A baked snack food product made by the method of claim 1.

24-39. (canceled)
